(19) United States
(12) Patent Application Publication
(10) Pub. No.: US 2007/0187451 A1
(43) Pub. Date: Aug. 16, 2007

(54) Pliers type stapler

(76) Inventor: Chun-Yuan Chang, Taichung (TW)

Correspondence Address: Charles E. Baxley, ESQ., 90 John Street - 3rd Floor, NEW YORK, NY, 10038, US

(21) Appl. No.: 11/353,216

(22) Filed: Feb. 14, 2006

(51) Int. Cl. B25C 5/00

(52) U.S. Cl. 227/129

(57) ABSTRACT

A pliers type stapler includes a case assembly, a magazine, a seat board, a striking plate, a trigger mechanism, and a push mechanism. Thus, the striking plate is lowered from its uppermost position to strike the staple to staple the article to be stapled instantaneously so that the striking plate has greater impact stroke and strength so as to staple the article efficiently without incurring deflection, thereby enhancing the stapling effect and quality of the stapler. In addition, the stapler is operated like pliers, so that the user can operate the stapler conveniently, thereby saving the manual work.

### BACKGROUND OF THE INVENTION

1. Field of the Invention

The present invention relates to a stapler and, more particularly, to a pliers type stapler.

2. Description of the Related Art

A conventional stapler comprises a base, an anvil mounted on the base, a case assembly pivotally mounted on the base by a hinge pin, a magazine and tie plate assembly pivotally mounted between the base and the case assembly and having a rail, a plurality of staples contained in the rail of the magazine and tie plate assembly, a follow block mounted in the rail of the magazine and tie plate assembly to block and push the staples, and a follow spring mounted between the case assembly and the follow block to drive the follow block. When the case assembly is pressed toward the base by a user, one of the staples is pressed toward the anvil to staple an article to be stapled, thereby accomplishing the stapling function.

However, the distance between the case assembly and the staples is very short, so that the force applied on the staples by the case assembly is limited, thereby decreasing the stapling effect of the stapler. In addition, the stapler has a complicated construction, thereby greatly increasing the costs of fabrication. Further, the stapler is not assembled easily and rapidly, thereby causing inconvenience in assembly of the stapler. Further, the staples are not placed into the magazine and tie plate assembly easily and rapidly, thereby causing inconvenience to the user when feeding the staples.

### SUMMARY OF THE INVENTION

In accordance with the present invention, there is provided a stapler, comprising stapler, comprising a case assembly including a first handle having a first end provided with a first mounting portion and a second mounting portion spaced from the first mounting portion and a second end provided with a first arm, and a second handle pivotally connected with the first handle and having a first end movably mounted in the first mounting portion of the first handle and a second end provided with a second arm movable relative to the first arm of the first handle; a magazine mounted in the first mounting portion of the first handle; a seat board mounted in the second mounting portion of the first handle and provided with a metallic plate having a first end provided with an anvil; a striking plate movably mounted in the magazine and movable relative to the anvil of the metallic plate; and a trigger mechanism mounted in the magazine and including a pivot member having a first end provided with a drive portion detachably attached to the striking plate to move the striking plate outward relative to the anvil of the metallic plate and a second end provided with a driven portion rested on and driven by the first end of the second handle, and a torsion spring biased between the magazine and the striking plate to provide a restoring force to move the striking plate toward the anvil of the metallic plate.

The primary objective of the present invention is to provide a pliers type stapler.

Another objective of the present invention is to provide a stapler, wherein the striking plate is lowered from its uppermost position to strike the staple to staple the article to be stapled instantaneously so that the striking plate has greater impact stroke and strength so as to staple the article efficiently without incurring deflection, thereby enhancing the stapling effect and quality of the stapler.

A further objective of the present invention is to provide a stapler, wherein the stapler is operated like pliers, so that the user can operate the stapler conveniently, thereby saving the manual work.

A further objective of the present invention is to provide a stapler, wherein the stapler has a simplified construction, thereby decreasing the costs of fabrication.

A further objective of the present invention is to provide a stapler, wherein the second handle is connected with the first handle, the magazine is mounted in the first handle, and the push mechanism is mounted on the magazine, so that the stapler is assembled easily and rapidly, thereby facilitating assembly of the stapler.

A further objective of the present invention is to provide a stapler, wherein the distal end of the magazine is exposed outwardly from the upright hollow bracket and the grip portion of the push mechanism is exposed from the guide slot of the magazine, so that the support bracket of the push mechanism is inserted into and detached from the guide slot of the magazine easily and rapidly, thereby facilitating the user feeding the staples.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a stapler in accordance with the preferred embodiment of the present invention.

FIG. 2 is an exploded perspective view of the stapler as shown in FIG. 1.

FIG. 3 is a plan cross-sectional view of the stapler as shown in FIG. 1.

FIG. 4 is a schematic operational view of the stapler as shown in FIG. 3 in use.

### DETAILED DESCRIPTION OF THE INVENTION

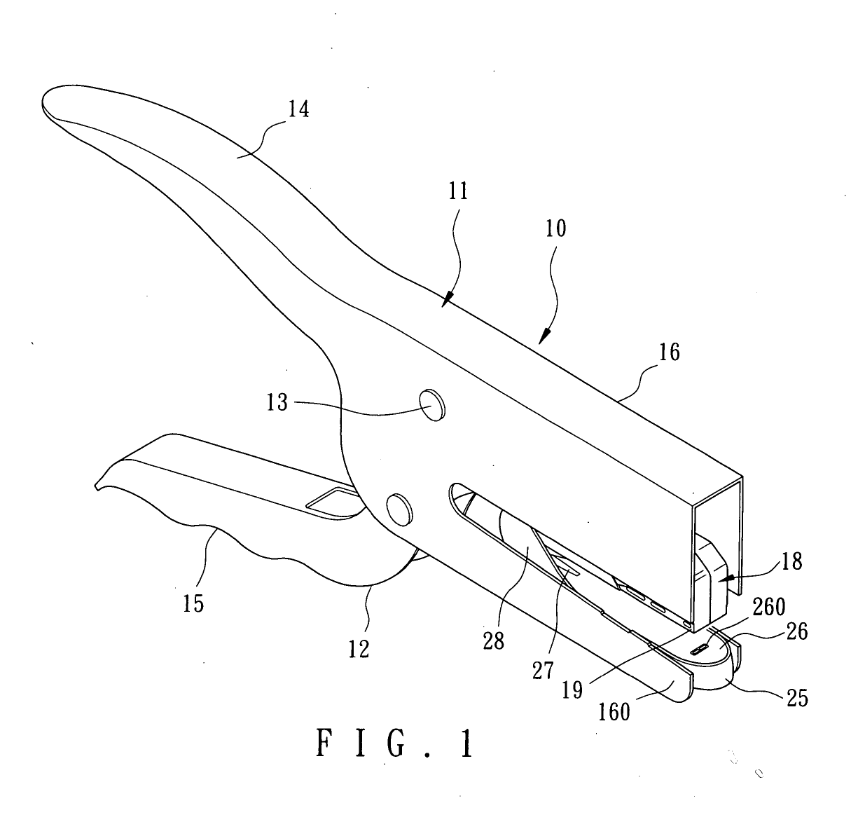

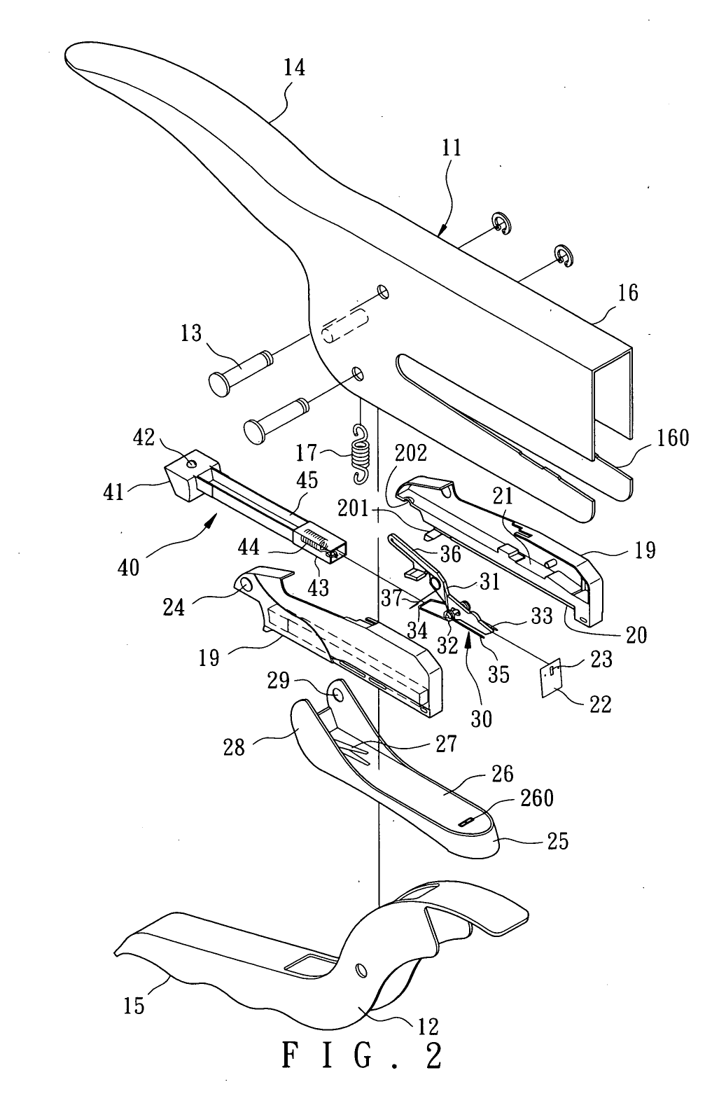

Referring to the drawings and initially to FIGS. 1-3, a pliers type stapler in accordance with the preferred embodiment of the present invention comprises a case assembly 10, a magazine 18, a seat board 25, a striking plate 22, a trigger mechanism 30, and a push mechanism 40.

The case assembly 10 includes a first handle 11 having a bifurcate first end provided with a first mounting portion 16 and a second mounting portion 160 spaced from the first mounting portion 16 and a second end provided with a first arm 14, and a second handle 12 pivotally connected with the first handle 11 and having a first end movably mounted in the first mounting portion 16 of the first handle 11 and a second end provided with a second arm 15 movable relative to the first arm 14 of the first handle 11. The second handle 12 is pivotally connected with the first handle 11 by a pivot shaft 13 which is located at a mediate portion of the first handle 11 and located adjacent to the first end of the second handle 12.

The case assembly 10 further includes a restoring spring 17 biased between the second mounting portion 160 of the first handle 11 and a mediate portion of the second handle 12 to pull the second arm 15 of the second handle 12 outwardly relative to the first arm 14 of the first handle 11. Thus, the second arm 15 of the second handle 12 and the first arm 14 of the first handle 11 are disposed at an open state normally by the elastic force of the restoring spring 17.

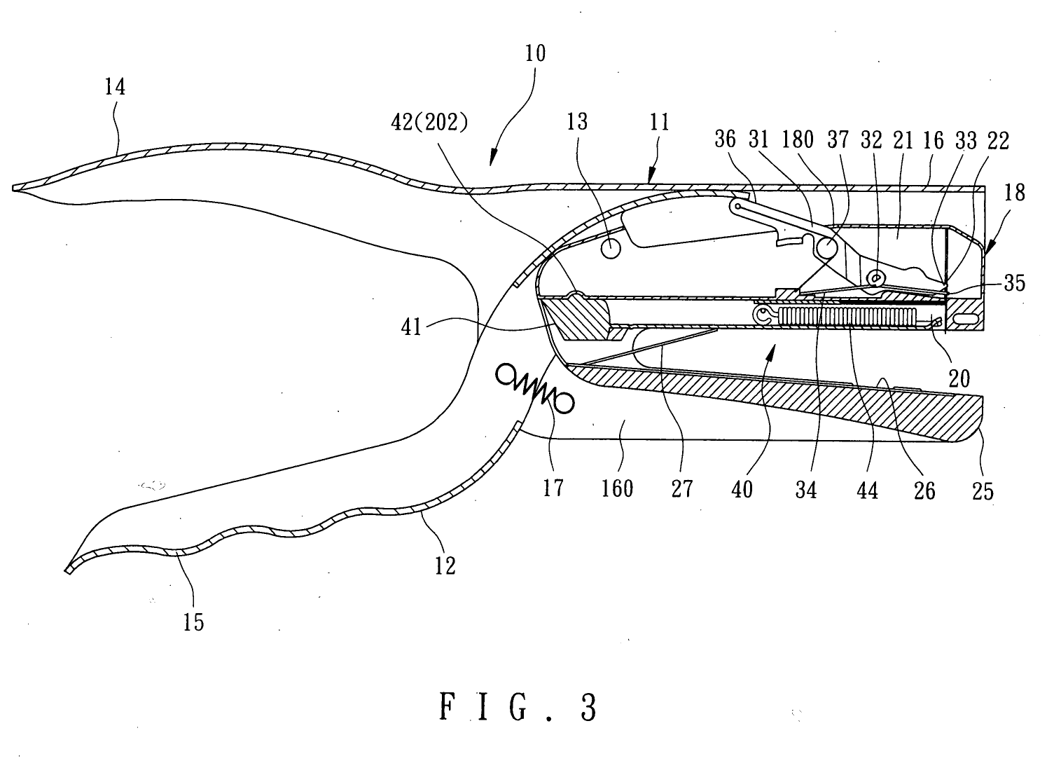

The magazine 18 is mounted in the first mounting portion 16 of the first handle 11 and includes two shells 19 combined with each other. The magazine 18 has an upper portion formed with a receiving chamber 21 to receive the trigger mechanism 30 and a lower portion formed with a guide slot 20 containing staples (not shown) therein. The magazine 18 has a top wall formed with an opening 180 (see FIG. 3) to expose the trigger mechanism 30. The guide slot 20 of the magazine 18 has a distal end provided with a stop plate 201 and formed with a positioning recess 202. The magazine 18 has a distal end provided with two opposite outwardly protruding pivot axles 24.

The seat board 25 is mounted in the second mounting portion 160 of the first handle 11 and has a top face provided with a metallic plate 26 having a first end provided with an anvil 260 and a second end provided with an elastic member 27 rested on a bottom of the magazine 18. The seat board 25 has a distal end provided with an upright hollow bracket 28 pivotally mounted on the magazine 18 whose distal end is exposed outwardly from the upright hollow bracket 28. The upright hollow bracket 28 has an inner wall formed with two opposite pivot holes 29 each mounted on the respective pivot axle 24 of the magazine 18.

The striking plate 22 is movably mounted in the magazine 18 and movable relative to the anvil 260 of the metallic plate 26. Preferably, the striking plate 22 is extended through the receiving chamber 21 and the guide slot 20 of the magazine 18 and has a distal end protruding from the guide slot 20 of the magazine 18. The striking plate 22 has a hook hole 23.

The trigger mechanism 30 is mounted in the magazine 18 and includes a pivot member 31 pivotally mounted on the magazine 18 and having a first end provided with a drive portion 33 detachably attached to the striking plate 22 to move the striking plate 22 outward relative to the anvil 260 of the metallic plate 26 and a second end provided with a driven portion 36 protruded from the opening 180 of the magazine 18 and rested on and driven by the first end of the second handle 12, a torsion spring 32 biased between the magazine 18 and the striking plate 22 to provide a restoring force to move the striking plate 22 toward the anvil 260 of the metallic plate 26, and a restoring spring 37 biased between the magazine 18 and the pivot member 31 to provide a restoring force to the pivot member 31. The drive portion 33 of the pivot member 31 is detachably hooked in the hook hole 23 of the striking plate 22. The torsion spring 32 is mounted on the first end of the pivot member 31 and has a first leg 34 rested on the magazine 18 and a second leg 35 locked to the striking plate 22 to move the striking plate 22. The pivot member 31 has a mediate portion pivotally mounted on the magazine 18, and the restoring spring 37 is mounted on the mediate portion of the pivot member 31 and has a first end rested on the magazine 18 and a second end rested on the driven portion 36 of the pivot member 31.

The push mechanism 40 is removably mounted on the magazine 18 to push the staples contained in the magazine 18. The push mechanism 40 includes a support bracket 45 mounted in the magazine 18, a slide 43 slidably mounted on the support bracket 45 and slidable in the guide slot 20 of the magazine 18, and a push spring 44 biased between the support bracket 45 and the slide 43 to push the slide 43 toward the striking plate 22. The support bracket 45 of the push mechanism 40 is detachably mounted in the guide slot 20 of the magazine 18 and has a distal end provided with an enlarged grip portion 41 exposed from the guide slot 20 of the magazine 18. The grip portion 41 of the support bracket 45 has a face provided with a positioning boss 42 detachably positioned in the positioning recess 202 of the magazine 18 so that the support bracket 45 of the push mechanism 40 is detachably positioned in the guide slot 20 of the magazine 18. The slide 43 of the push mechanism 40 is stopped by the stop plate 201 of the magazine 18 to prevent the push mechanism 40 from being detached from the magazine 18.

In practice, when the second arm 15 of the second handle 12 and the first arm 14 of the first handle 11 are movable toward each other, the driven portion 36 of the pivot member 31 is pressed by the first end of the second handle 12 to move toward the seat board 25, and the drive portion 33 of the pivot member 31 is driven to move outward relative to the seat board 25 to move the striking plate 22 outward relative to the anvil 260 of the metallic plate 26. At this time, when the striking plate 22 is movable outward relative to the anvil 260 of the metallic plate 26, the torsion spring 32 is distorted to provide a restoring force to move the striking plate 22 toward the anvil 260 of the metallic plate 26 after the drive portion 33 of the pivot member 31 is movable to detach from the striking plate 22.

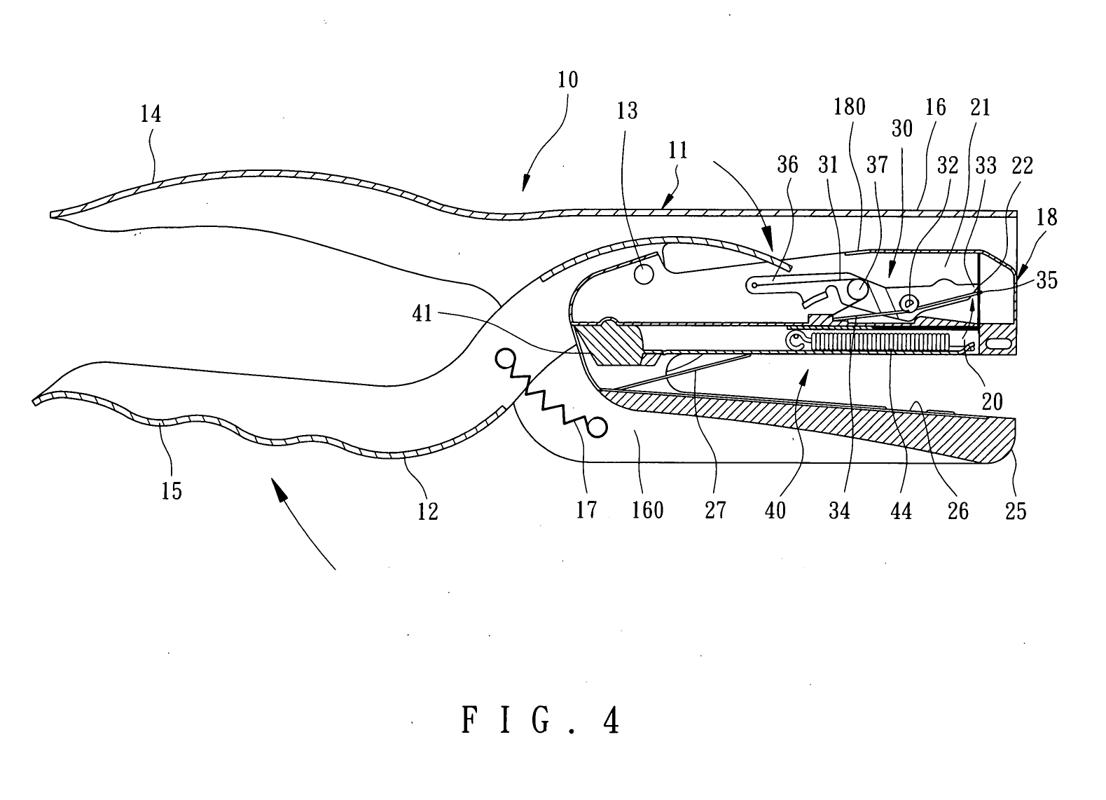

As shown in FIG. 4, when the second arm 15 of the second handle 12 and the first arm 14 of the first handle 11 are pressed and moved toward each other, the driven portion 36 of the pivot member 31 is pressed by the first end of the second handle 12 to move toward the seat board 25, and the drive portion 33 of the pivot member 31 is driven to move outward relative to the seat board 25 so that the striking plate 22 is moved upwardly relative to the anvil 260 of the metallic plate 26.

After the drive portion 33 of the pivot member 31 is lifted to its uppermost position, the drive portion 33 of the pivot member 31 is detached from the hook hole 23 of the striking plate 22 to release the striking plate 22, so that the striking plate 22 is moved toward the anvil 260 of the metallic plate 26 by the restoring force of the torsion spring 32 to strike the staples of the magazine 18, thereby achieving the stapling function.

Accordingly, the striking plate 22 is lowered from its uppermost position to strike the staple to staple the article to be stapled instantaneously so that the striking plate 22 has greater impact stroke and strength so as to staple the article efficiently without incurring deflection, thereby enhancing the stapling effect and quality of the stapler. In addition, the stapler is operated like pliers, so that the user can operate the stapler conveniently, thereby saving the manual work. Further, the stapler has a simplified construction, thereby decreasing the costs of fabrication. Further, the second handle 12 is connected with the first handle 11, the magazine 18 is mounted in the first handle 11, and the push mechanism 40 is mounted on the magazine 18, so that the stapler is assembled easily and rapidly, thereby facilitating assembly of the stapler. Further, the distal end of the magazine 18 is exposed outwardly from the upright hollow bracket 28 and the grip portion 41 of the push mechanism 40 is exposed from the guide slot 20 of the magazine 18, so that the support bracket 45 of the push mechanism 40 is inserted into and detached from the guide slot 20 of the magazine 18 easily and rapidly, thereby facilitating the user feeding the staples.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A stapler, comprising:
a case assembly including a first handle having a first end provided with a first mounting portion and a second mounting portion which is spaced from the first mounting portion and having a second end provided with a first arm,
a second handle pivotally connected with the first handle and having a first end movably mounted in the first mounting portion of the first handle and having a second end provided with a second arm movable relative to the first arm of the first handle;
a magazine mounted in the first mounting portion of the first handle;
a seat board mounted in the second mounting portion of the first handle and provided with a metallic plate having a first end provided with an anvil;
a striking plate movably mounted in the magazine and movable relative to the anvil of the metallic plate, the striking plate including a hook hole formed therein;
a trigger mechanism mounted in the magazine and including a pivot member having a first end provided with a drive portion detachably hooked in the hook hole of the striking plate to move the striking plate outward relative to the anvil of the metallic plate and a second end provided with a driven portion rested on and driven by the first end of the second handle, and
a torsion spring biased between the magazine and the striking plate and including a first leg rested on the magazine and a second leg locked to the striking plate to move the striking plate and to provide a restoring force to move the striking plate toward the anvil of the metallic plate, and
the driven portion of the pivot member being pressed by the first end of the second handle to move toward the seat board, and the drive portion of the pivot member being driven to move outward relative to the seat board to move the striking plate outward relative to the anvil of the metallic plate when the second arm of the second handle and the first arm of the first handle are moved toward each other, and the torsion spring being distorted to provide a restoring force to move the striking plate toward the anvil of the metallic plate when the striking plate is moved outward relative to the anvil of the metallic plate and after the drive portion of the pivot member is detached from the striking plate.

2. The stapler in accordance with claim 1, wherein the magazine has a lower portion formed with a guide slot.

3. The stapler in accordance with claim 2, wherein the magazine has an upper portion formed with a receiving chamber to receive the trigger mechanism.

4. The stapler in accordance with claim 1, wherein the magazine has a top wall formed with an opening to expose the trigger mechanism, and the driven portion of the trigger mechanism is protruded from the opening of the magazine.

5. The stapler in accordance with claim 1, wherein the magazine includes two shells combined with each other.

6. The stapler in accordance with claim 1, wherein the seat board has a second end provided with an elastic member rested on a bottom of the magazine.

7. The stapler in accordance with claim 1, wherein the seat board has a distal end provided with an upright hollow bracket pivotally mounted on the magazine whose distal end is exposed outwardly from the upright hollow bracket.

8. The stapler in accordance with claim 7, wherein the magazine has a distal end provided with two opposite outwardly protruding pivot axles, and the upright hollow bracket has an inner wall formed with two opposite pivot holes each mounted on the respective pivot axle of the magazine.

9. The stapler in accordance with claim 2, wherein the striking plate is extended through the receiving chamber and the guide slot of the magazine and has a distal end protruding from the guide slot of the magazine.

10. (canceled)

11. The stapler in accordance with claim 1, wherein the torsion spring is mounted on the first end of the pivot member.

12. The stapler in accordance with claim 2, further comprising a push mechanism removably mounted on the magazine and including a support bracket mounted in the magazine, a slide slidably mounted on the support bracket and slidable in the guide slot of the magazine, and a push spring biased between the support bracket and the slide to push the slide toward the striking plate.

13. The stapler in accordance with claim 12, wherein the support bracket of the push mechanism is detachably mounted in the guide slot of the magazine and has a distal end provided with an enlarged grip portion exposed from the guide slot of the magazine.

14. The stapler in accordance with claim 13, wherein the guide slot of the magazine has a distal end formed with a positioning recess, and the grip portion of the support bracket has a face provided with a positioning boss detachably positioned in the positioning recess of the magazine so that the support bracket of the push mechanism is detachably positioned in the guide slot of the magazine.

15. The stapler in accordance with claim 12, wherein the guide slot of the magazine has a distal end provided with a stop plate, and the slide of the push mechanism is stopped by the stop plate of the magazine to prevent the push mechanism from being detached from the magazine.

16-17. (canceled)

18. The stapler in accordance with claim 1, wherein the case assembly further includes a restoring spring biased between the second mounting portion of the first handle and a mediate portion of the second handle to pull the second arm of the second handle outwardly relative to the first arm of the first handle.

19. The stapler in accordance with claim 1, wherein the trigger mechanism further includes a restoring spring biased between the magazine and the pivot member to provide a restoring force to the pivot member.

20. The stapler in accordance with claim 19, wherein the pivot member of the trigger mechanism has a mediate portion pivotally mounted on the magazine, and the restoring spring is mounted on the mediate portion of the pivot member and has a first end rested on the magazine and a second end rested on the driven portion of the pivot member.
